(19) United States
(12) Patent Application Publication
(10) Pub. No.: US 2014/0347807 A1
(43) Pub. Date: Nov. 27, 2014

(54) RELEASING APPARATUS FOR SUBSCRIBER IDENTITY MODULE CARD

(71) Applicants: HON HAI PRECISION INDUSTRY CO., LTD., New Taipei (CN); HONG FU JIN PRECISION INDUSTRY (ShenZhen) CO., LTD., ShenZhen (CN)

(72) Inventor: XIN YANG, Shenzhen (CN)

(21) Appl. No.: 13/928,214

(22) Filed: Jun. 26, 2013

(30) Foreign Application Priority Data
May 24, 2013 (CN) 2013101965996

(51) Int. Cl. G06F 1/18

(52) U.S. Cl. CPC G06F 1/186
USPC 361/679.32; 211/41.12

(57) ABSTRACT

A releasing apparatus for a subscriber identity module (SIM) card includes a bracket defining a first latching slot, a rack received in the bracket for supporting the SIM card, a movable member attached to the bracket, a pivot member pivotably attached to the bracket, and a resilient member sandwiched between the bracket and the movable member. The rack defines a second latching slot aligned with the first latching slot. The movable member includes a tab and a biasing protrusion latched in the first and second latching slots. The pivot member rotates to bias the tab to move away from the first latching slot. The biasing protrusion is disengaged from the first and second latching slots when the biasing protrusion biases the rack with the SIM card away from the bracket.

### BACKGROUND

1. Technical Field

The disclosure relates to a releasing apparatus for a subscriber identity module (SIM) card.

2. Description of Related Art

A SIM card is usually fitted in an electronic device such as a mobile phone. The SIM card needs to be firmly engaged in the electronic device to ensure complete electrical connection. However, it is difficult to release the SIM card without damaging it due to its small size.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of an embodiment of a releasing apparatus with a subscriber identity module (SIM) card, wherein the releasing apparatus includes a bracket and a pivot member.

FIG. 2 is similar to FIG. 1, but viewed from another perspective.

FIG. 3 is an enlarged view of the bracket of FIG. 1, but viewed from another perspective.

FIG. 4 is an enlarged view of the pivot member of FIG. 1, but viewed from another perspective.

FIG. 5 is an assembled, isometric view of the releasing apparatus of FIG. 1.

FIGS. 6-8 are partially cutaway views of FIG. 5, but showing the processes of releasing the SIM card.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean “at least one.”

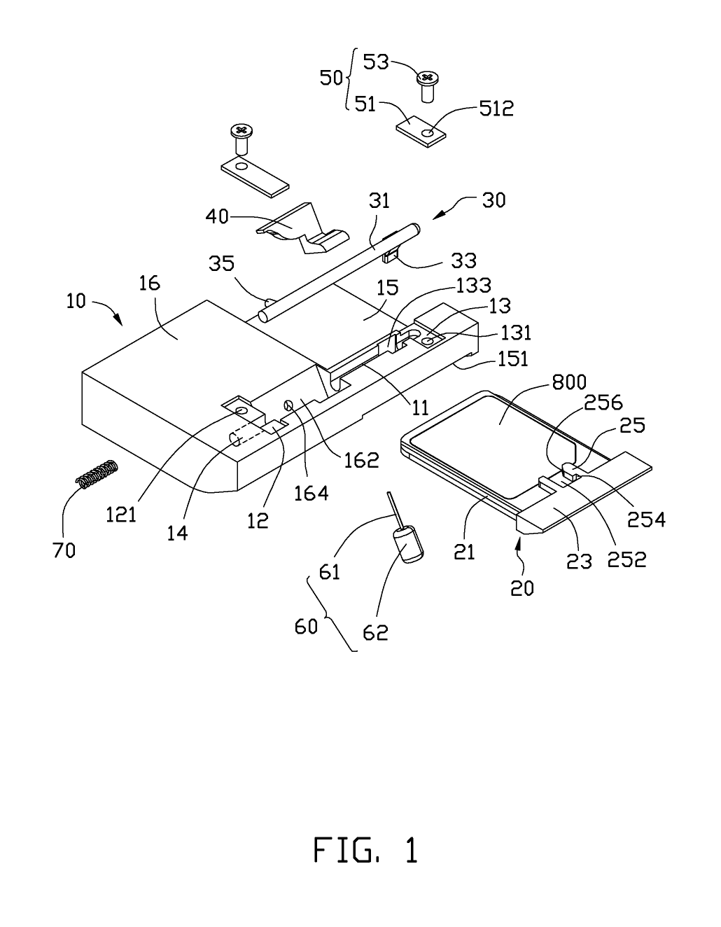

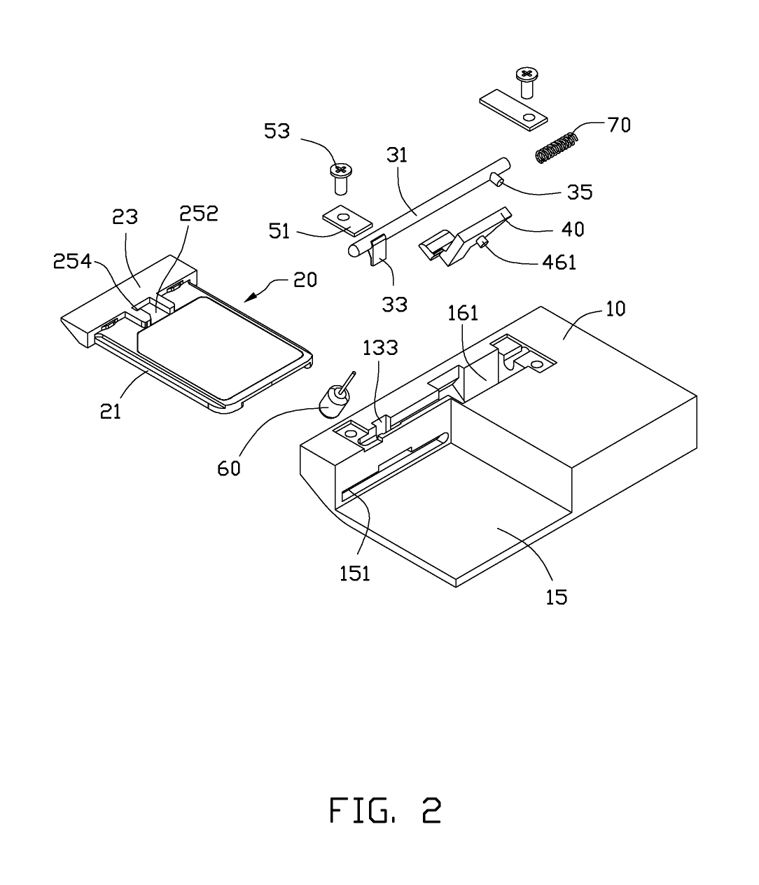

FIG. 1 and FIG. 2 show a releasing apparatus for a subscriber identity module (SIM) card 800. The releasing apparatus includes a bracket 10, a rack 20, a movable member 30, a pivot member 40, two fastening members 50, an operation member 60, and a resilient member 70.

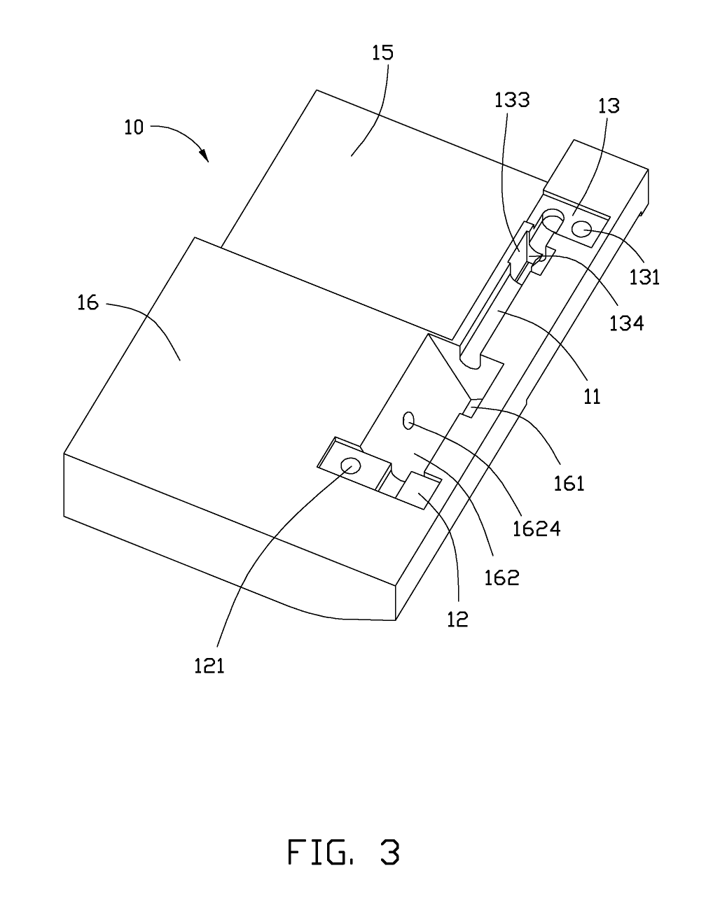

FIG. 3 shows an elongated receiving slot 11 defined in a side of a top side of the bracket 10 and a first recess 12 and a second recess 13 defined in the top side of the bracket 10. The first and second recesses 12 and 13 are located at opposite ends of the receiving slot 11 and communicate with the receiving slot 11. The first and second recesses 12 and 13 define a first fastening hole 121 and a second fastening hole 131 in bottom surfaces of the first and second recesses 12 and 13, respectively. A receiving space 15 is defined in a first end of the top side of the bracket 10 at a side of the receiving slot 11, and a raised portion 16 is formed at an opposite second end of the top of the bracket 10. A through hole 161 is defined in the raised portion 16 adjacent to the first recess 12. The through hole 161 extends from top to bottom of the raised portion 16 and communicates with the receiving slot 11. A sloped surface 162 is formed on the raised portion 16 and faces and bounds the through hole 161. A pivot hole 164 is defined in the sloped surface 162. A rack slot 151 is defined below the receiving slot 11 in a bottom side of the bracket 10 and communicates with the receiving space 15. A positioning hole 14, which extends along a direction of the receiving slot 11, is defined in the top side of the bracket 10 in a side of the first recess 12 and faces the receiving slot 11. A through hole 133 is defined in the bracket 10 adjacent to the second recess 13, and extends from the top side to the bottom side of the bracket 10, and communicates with the receiving slot 11 and the rack slot 151. A latching slot 134 is defined in a sidewall bounding the through hole 133 and communicates with the receiving slot 11 and the through hole 133. The latching slot 134 is adjacent to the second recess 13.

The rack 20 includes a plate 21 and a stepped portion 23 formed from an end of the plate 21. Two opposite guiding bars 25 protrude out from a middle of the stepped portion 23. The guiding bars 25 cooperatively bound a guiding slot 252. An end of one of the guiding bars 25 defines a latching slot 254 that communicates with the guiding slot 252. A distal end of the guiding bar 25 defining the latching slot 254 forms a guiding surface 256 facing the guiding slot 252. The SIM card 800 is placed on the plate 21.

The movable member 30 includes a shaft 31, a biasing protrusion 33 extending from a first end of a circumference of the shaft 31, and a tab 35 extending from a second end of the circumference of the shaft 31. The biasing protrusion 33 is right-angled to the tab 35.

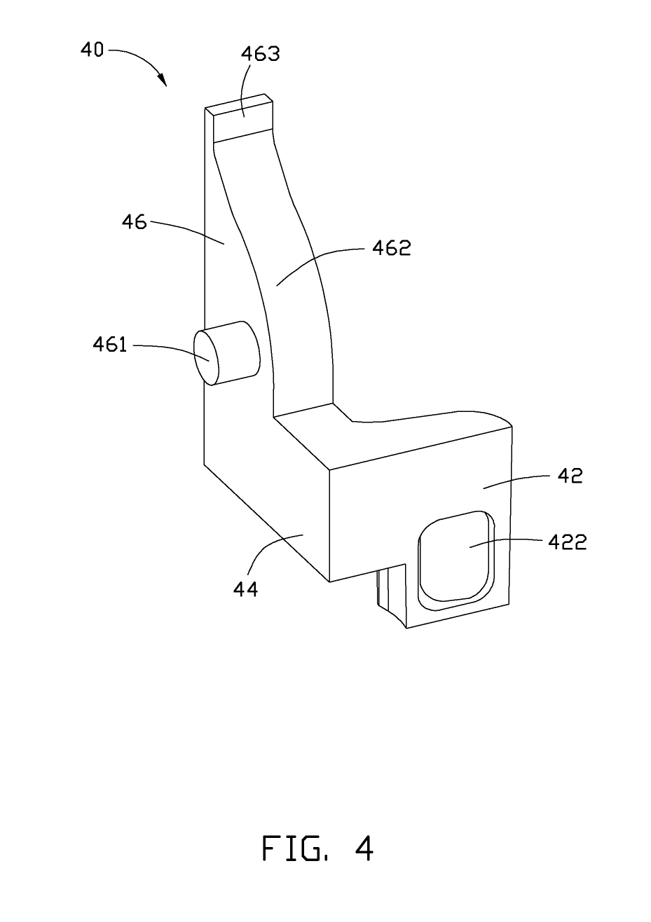

Referring to FIG. 4, the pivot member 40 includes a rectangular connecting plate 44, an engaging plate 42 extending substantially perpendicularly from a first end of the connecting plate 44, and a biasing plate 46 extending substantially perpendicularly from a second end of the connecting plate 44 and substantially perpendicular to the engaging plate 42. A pivot pole 461 extends substantially perpendicularly from the biasing plate 46. The biasing plate 46 defines an arc-shaped pressing surface 462 facing the engaging plate 42. The biasing plate 46 includes a distal end 463 substantially parallel to the engaging plate 42. A depressed portion 422 is defined in the engaging plate 42 opposite to the biasing plate 46.

Each fastening member 50 includes a plate 51 and a screw 53. The plate 51 defines a through hole 512.

The operation member 60 includes a columnar handle 62 and a pin 61 extending from one end of the handle 62.

In one embodiment, the resilient member 70 is a spring.

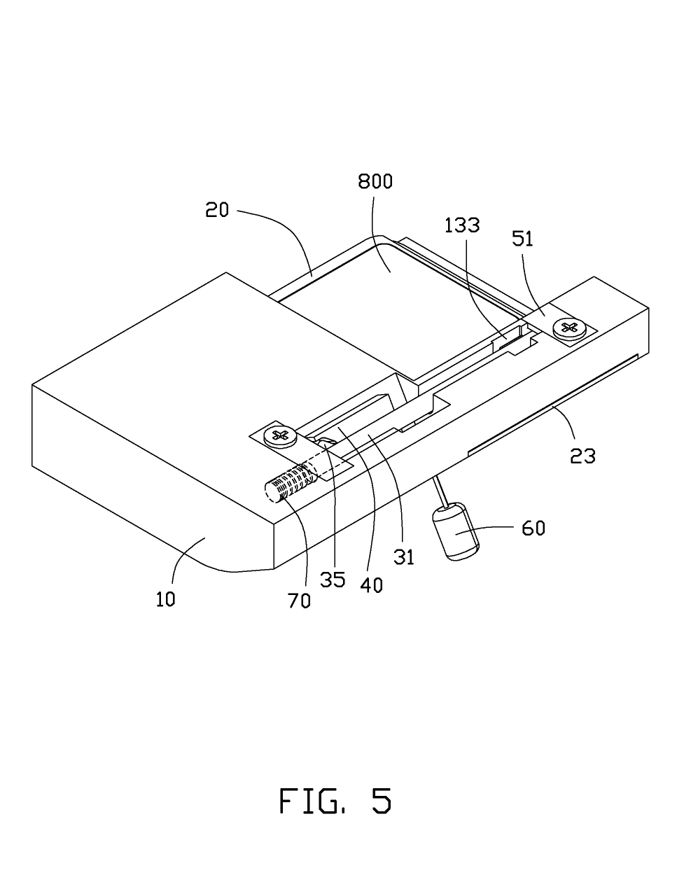

FIG. 5 shows that in assembly of the releasing apparatus, the pivot member 40 is placed on the sloped surface 162. The pivot pole 461 is pivotably inserted in the pivot hole 1624. The resilient member 70 is inserted in the positioning hole 14. The movable member 30 is received in the receiving slot 11 with the biasing protrusion 33 received in the through hole 133. The second end of the shaft 31 is inserted in the positioning hole 14 to abut against the resilient member 70 to allow the biasing protrusion 33 to be inserted into the latching slot 134. The plates 51 are located in the first and second recesses 12 and 13, and the screws 53 extend through the through holes 512 to be screwed into the corresponding fastening holes 121 and 131. The tab 35 is under the pressing surface 462 of the biasing plate 46. The rack 20 is inserted into the receiving space 15 through the rack slot 151. The guiding surface 256 of the guiding bar 25 slidably abuts against the biasing protrusion 33 to allow the shaft 31 to compress the resilient member 70 until the biasing protrusion 33 is disengaged from the latching slot 134 and is received in the guiding slot 252 of the rack 20. The rack 20 is further pushed toward the receiving space 15, and the biasing protrusion 33 is slidably received in the guiding slot 252 until the biasing protrusion 33 aligns with the latching slot 254 and the latching slot 134. The resilient member 70 restores and the biasing protrusion 33 latches in the latching slot 254 of the guiding bar 25 and the latching slot 134 of the bracket 10. The stepped portion 23 is received in the rack slot 151.

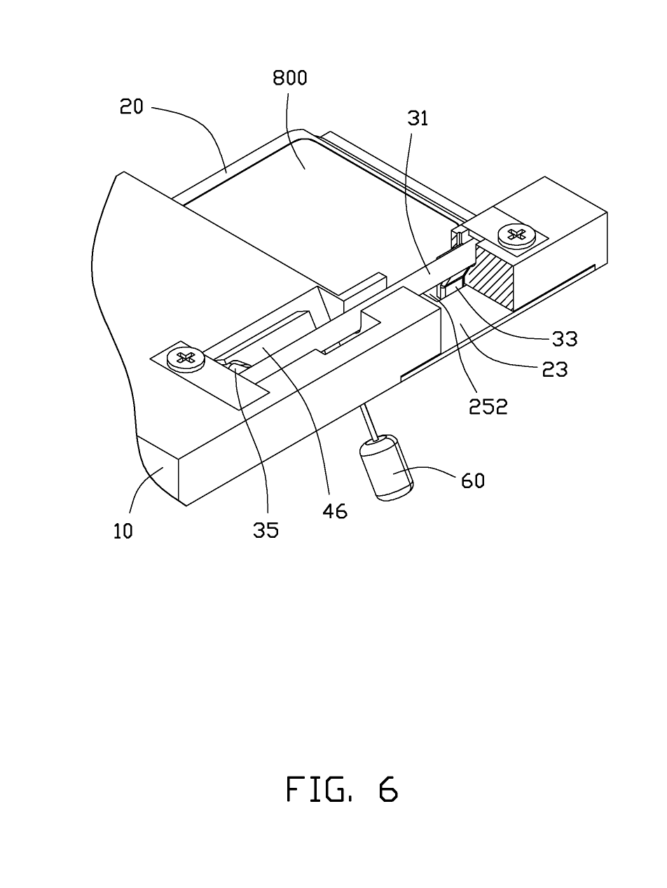

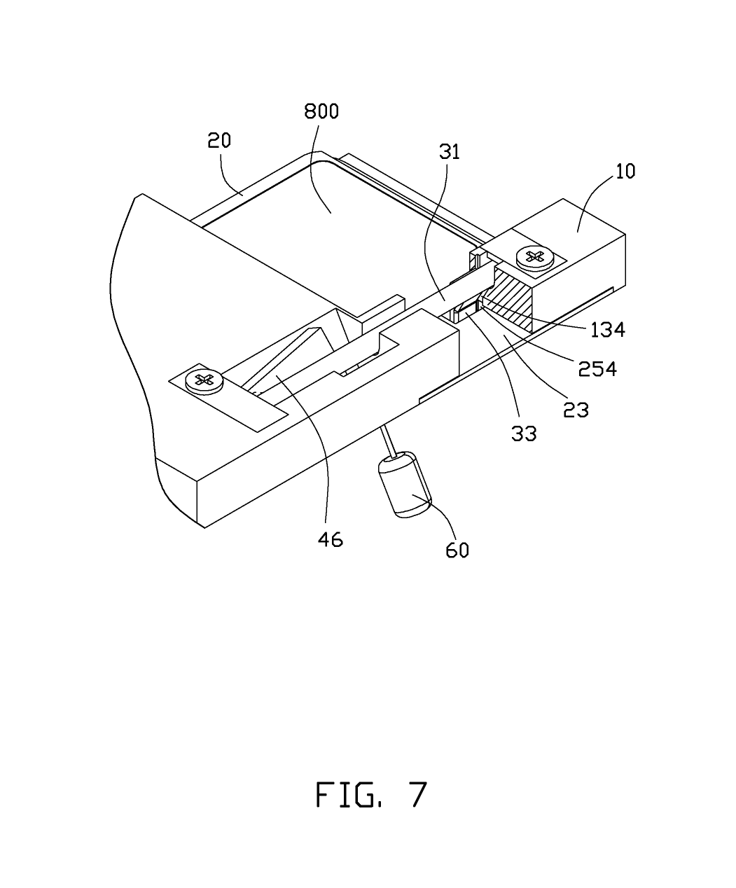

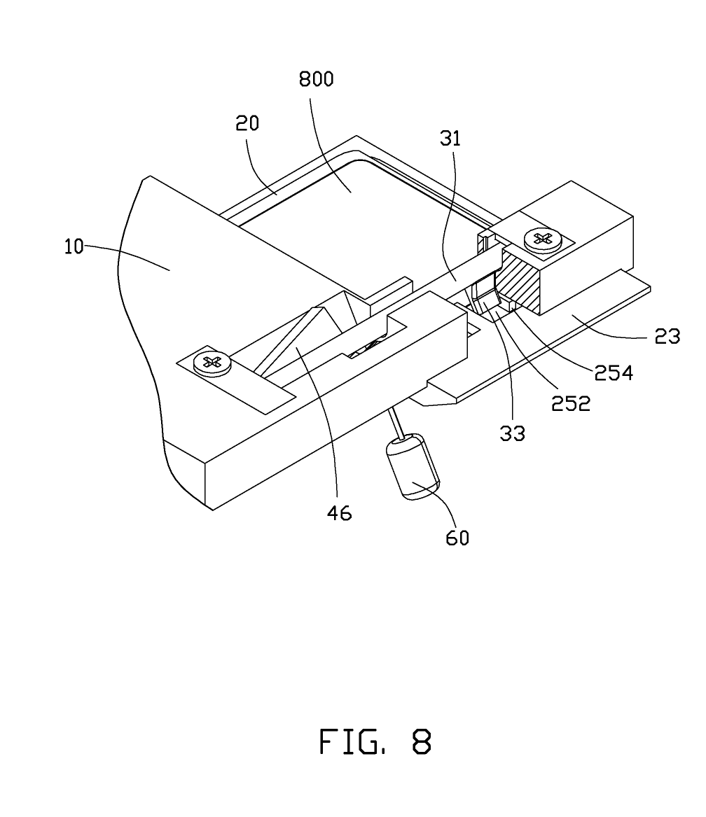

FIGS. 6-8 show in use, when releasing the SIM card 800, the pin 61 of the operation member 60 abuts against the depressed portion 422 of the engaging plate 42 through the through hole 161. The pivot member 40 is pivoted about the pivot pole 461. The pressing surface 462 of the biasing plate 46 biases the tab 35 to move the movable member 30 to compress the resilient member 70 until the biasing protrusion 33 is disengaged from the two latching slots 134 and 254. The pin 61 abuts against the depressed portion 422 again, and the distal end 463 of the biasing plate 46 biases the tab 35 to rotate the movable member 30. The biasing protrusion 33 engages with the stepped portion 23 to move the rack 20 out of the receiving space 15 through the rack slot 151. After the stepped portion 23 moves out of the rack slot 151, the rack 20 and the SIM card 800 can be easily removed from the bracket 10.

It is to be understood, however, that even though numerous characteristics and advantages of certain embodiments have been set forth in the foregoing description, together with details of the structures and functions of the embodiments, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A releasing apparatus for a subscriber identity module (SIM) card, the releasing apparatus comprising:
a bracket defining a first latching slot;
a rack supporting the SIM card and detachably mounted to the bracket, the rack defining a second latching slot aligning with the first latching slot of the bracket when the rack is mounted to the bracket;
a movable member movably attached to the bracket, wherein the movable member comprises a biasing protrusion detachably latched in the first latching slot and the second latching slot, and a tab, the biasing protrusion and the tab formed at opposite ends of the movable member;
a pivot member comprising a pivot pole, and a biasing plate and an engaging plate located at opposite sides of the pivot pole, wherein the pivot member is pivotably attached to the bracket through the pivot pole; and
a resilient member resiliently sandwiched between the bracket and the movable member;
wherein the biasing plate forms a pressing surface, the engaging plate of the pivot member is operable to rotate the pivot member about the pivot pole, the pressing surface of the pivot member biases the tab of the movable member to move the movable member away from the first latching slot and the second latching slot, and the biasing protrusion is disengaged from the first latching slot and the second latching slot when the biasing protrusion biases the rack to move away from the bracket.

2. The releasing apparatus of claim 1, wherein the movable member further comprises a shaft movably received in the bracket, the biasing protrusion extends down from a first end of a circumference of the shaft, the tab extends from a second end of the circumference of the shaft, and the biasing protrusion and the tab are right-angled.

3. The releasing apparatus of claim 2, wherein the bracket defines a receiving slot in a top of the bracket, and the shaft is movably received in the receiving slot.

4. The releasing apparatus of claim 3, wherein the bracket defines a receiving space at a side of the receiving slot to receive the rack, and a rack slot communicating with the receiving space; the rack enters the receiving space through the rack slot.

5. The releasing apparatus of claim 4, wherein the bracket further defines a through hole communicating with the receiving slot and the rack slot, the first latching slot is defined in a sidewall bounding the through hole and communicates with the receiving slot and the rack slot, the biasing protrusion of the movable member extends through the through hole to be positioned in the first latching slot to position the rack.

6. The releasing apparatus of claim 5, wherein the rack comprises a stepped portion formed from one end of the rack, and two opposite guiding bars protrude up from the stepped portion and substantially perpendicular to the stepped portion, the guiding bars cooperatively bound a guiding slot, the second latching slot is defined in one of the guiding bars and communicates with the guiding slot, the stepped portion is located in the slot with the second latching slot aligning with the first slot of the bracket, and the biasing protrusion is latched in the second latching slot and the first latching slot, when the rack is mounted to the bracket.

7. The releasing apparatus of claim 6, wherein a distal end of the guiding bar defining the second latching slot forms a guiding surface facing the guiding slot, the guiding surface slidably abuts against the biasing protrusion, to allow the shaft to move to deform the resilient member, until the biasing protrusion is disengaged from the second latching hole and is received in the guiding slot.

8. The releasing apparatus of claim 4, wherein the bracket forms a raised portion at a side of the receiving space, the raised portions forms a sloped surface facing the receiving slot, and a pivot hole is defined in the sloped surface to pivotably receive the pivot pole of the movable member.

9. The releasing apparatus of claim 3, wherein the bracket defines a positioning hole extending along an extending direction of the receiving slot and communicating with the receiving slot, the resilient member is received in the positioning hole, and two opposite ends of the resilient member abut against the shaft and the bracket, respectively.

10. The releasing apparatus of claim 1, wherein the engaging plate defines a depressed portion.

11. A subscriber identity module (SIM) card assembly comprising:
a SIM card;
a bracket defining a first latching slot;
a rack supporting the SIM card and detachably received in the bracket, the rack defining a second latching slot aligning with the first latching slot of the bracket when the rack is mounted to the bracket;
a movable member movably attached to the bracket, wherein the movable member comprises a biasing protrusion detachably latched in the first latching slot and the second latching slot, and a tab, and the biasing protrusion and the tab are formed at opposite ends of the movable member;
a pivot member comprising a pivot pole, and a biasing plate and an engaging plate located at opposite sides of the pivot pole, wherein the pivot member is pivotably attached to the bracket through the pivot pole; and
a resilient member resiliently sandwiched between the bracket and the movable member;
wherein the biasing plate forms a pressing surface, the engaging plate of the pivot member is operable to rotate the pivot member about the pivot pole, the pressing surface of the pivot member biases the tab of the movable member to move the movable member away from the first latching slot and the second latching slot, the biasing protrusion is disengaged from the first latching slot and the second latching slot when the biasing protrusion biasing the rack together with the SIM card to move away from the bracket.

12. The SIM card assembly of claim 11, wherein the movable member further comprises a shaft movably received in the bracket, the biasing protrusion extends down from a first end of a circumference of the shaft, the tab extends from a second end of the circumference of the shaft, and the biasing protrusion and the tab are right-angled.

13. The SIM card assembly of claim 11, wherein the engaging plate defines a depressed portion.

14. The SIM card assembly of claim 12, wherein the bracket defines a receiving slot in a top of the bracket, the shaft is received in the receiving slot.

15. The SIM card assembly of claim 14, wherein the bracket defines a receiving space at a side of the receiving slot to receive the rack, and a rack slot communicating with the receiving space, the rack enters the receiving space through the rack slot.

16. The SIM card assembly of claim 15, wherein the bracket further defines a through hole communicating with the receiving slot and the slot, the first latching slot is defined in a sidewall bounding the through hole and communicates with the receiving slot and the rack slot, and the biasing protrusion of the movable member extends through the through hole to be positioned in the first latching slot to position the rack.

17. The SIM card assembly of claim 16, wherein the rack comprises a stepped portion formed from one end of the rack, and two opposite guiding bars protruding up from the stepped portion and substantially perpendicular to the stepped portion, the guiding bars cooperatively bound a guiding slot, the second latching slot is defined in one of the guiding bars and communicates with the guiding slot, the stepped portion is located in the slot with the second latching slot aligning with the first latching slot of the bracket, and the biasing protrusion is latched in the second latching slot and the first latching slot, when the rack is received in the bracket.

18. The SIM card assembly of claim 17, wherein a distal end of the guiding bar defining the latching slot forms a guiding surface facing the guiding slot, the guiding surface slidably abuts against the biasing protrusion, to allow the shaft to move to deform the resilient member, until the biasing protrusion is disengaged from the latching hole and is received in the guiding slot.

19. The SIM card assembly of claim 15, wherein the bracket forms a raised portion at a side of the receiving space, the raised portions forms a sloped surface facing the receiving slot, and a pivot hole is defined in the sloped surface to pivotably receive the pivot pole of the movable member.

20. The SIM card assembly of claim 14, wherein the bracket defines a positioning hole, extending along an extending direction of the receiving slot and communicating with the receiving slot, the resilient member is received in the positioning hole, and two opposite ends of the resilient member abut against the shaft and the bracket, respectively.
